(19) United States
(12) Patent Application Publication
(10) Pub. No.: US 2024/0380789 A1
(43) Pub. Date: Nov. 14, 2024

(54) Quantum Based Cyber Security System To Prevent Insider Attacks

(71) Applicant: Timothy William Edgin, Houston, TX (US)

(72) Inventor: Timothy William Edgin, Houston, TX (US)

(21) Appl. No.: 18/197,055

(22) Filed: May 13, 2023

(51) Int. Cl. H04L 9/40

(52) U.S. Cl. CPC H04L 63/205

(57) ABSTRACT

A cyber security system mainly designed to prevent insider attacks. A security importance number is probabilistically assigned to each relevant object that the user wishes to protect. Then whenever a change is requested of a particular protected object, a security importance number threshold check is probabilistically made based on N+1 generated administrative profiles which then have a time limit to manually interfere with the predicted outcome before a change is implemented.

### RELATED APPLICATION

This application is a continuation of U.S. Ser. No. 18/126,451 filed on Mar. 26, 2023, and is incorporated in its entirety.

### PRIOR ART

While there are systems available to detect insider attacks such as US 2021/0258336, the available prior art does nothing to prevent these insider attacks. There are also systems that are able to automatically remedy cyber security breaches such as US 2018/0159887, however these systems are normally implemented after system wide damage is done.

### BACKGROUND OF THE INVENTION

Cyber insurance risk currently stands at 40 billion in risk, and collected premiums are only 8.5 billion. Due to threat from Russia the current risk cannot be quantified due to the crossover of state and non-state actors in Russian ransom ware gangs.

The two greatest challenges facing cybersecurity today are insider threats, and state/non-state ransomware gangs. The present subject matter reduces both of these risks.

Currently, corporations rely on cybersecurity engineers, managers, and directors to maintain critical systems. The risk comes when any one account or account owner belonging to these holders of the “Keys of the Kingdom” they can often do extensive damage beyond the scope of what a cyber insurance policy will cover.

### SUMMARY OF THE INVENTION

The present subject matter uses traditional Users and Administrator accounts in combination with machine learning to build administrative profiles. While the present subject matter still requires every object in the corporation is given a security importance number (5), for instance the standard could be N5 or a color-coded scheme (n to n+5), as in the previously filed U.S. Ser. No. 18/126,451, however, individual administrative profiles are compiled based on previous behaviors to determine the probability of allowing a change to an object in the system. In this expanded system, each object has security importance weight number, and each administrator account is given a physical or logical device that contains one or several qubits in a specific spin state. Each of the qubits will be measured and that measure will serve as a quantum key. Only when all quantum keys are combined can the object in question be unlocked. For example, if administrator (1) has a qubit with an z axis spin that is measured to be some number, to keep it simple let say this number is 0.3. Another administrator has a qubit with a spin z axis 2.89 and another has one 2.79. On an object with a security number of three, the sum of their energies would be the encryption key. In this simplistic case the key would be qubits with a combined energy of 8.68.

As in U.S. Ser. No. 18/126,451, objects with a classification of n require only one administrator to make changes to it, N+1 requires 2 administrators to make changes, and n+5, the most secure objects, require 6 administrators all concurrently agreeing the change should be made.

However, once sufficient information has been compiled on each administrator, these decisions are then able to be assigned a likelihood of approval or disapproval based on each individual administrator's prior decision making. The present subject matter then compares this likelihood of success for each administrative profile to the requested change's security importance number and determines if there is enough administrative support to make the system change.

In some embodiments, for Domain Controllers and SQL Databases N+3 could be the standard. For secret n documents N=5.

As in U.S. Ser. No. 18/126,451, after each security importance number has been assigned to each relevant object in the company's technical infrastructure, whenever a system change request (10) is made, that approval threshold from the security importance number (5) must be meet within an approval time limit (15). However, in the present subject matter is able to monitor and determine security importance numbers of each object in the system.

The present subject matter then creates security importance number profiles which can be implemented and assign security importance numbers to individual objects through machine learning.

As in U.S. Ser. No. 18/126,451, the predetermined and appropriate number of approved administrators then must each individually approve of the change within the approval time limit (15) for the change to be implemented system wide (20). These approval time limits are finite and user configurable. However, the present subject matter is able to assign approval time limits which provide administrators an opportunity to override an upcoming approval or rejection of a system change.

As in U.S. Ser. No. 18/126,451, if the security importance number threshold check (25) is manually exceeded by administrative consent and it is done within the approval time limit check (30), then the requested system change will be granted (20). However, in the present subject matter if the security importance number threshold check ( ) is probabilistically exceeded by administrative consent and is not overridden within the approval time limit check ( ) then the requested system change will be granted ( )

As in U.S. Ser. No. 18/126,451, if the security importance number threshold check (25) of N+1 is not exceeded, then system change denied (35) will occur and the change to the system will not go through as requested. However, in the present subject matter if the security importance number threshold check ( ) is probabilistically not exceeded, then the system change denied ( ) will occur and the change to the system will not go through as requested.

As in U.S. Ser. No. 18/126,451, if the security importance number threshold check (25) of N+1 is manually exceeded, but the then the approval time limit check (30) is not met, then system change denied (35) will occur and the change to the system will not go through as requested. However, in the present subject matter if the security importance number threshold check is probabilistically initially exceeded by administrative consent and is manually overridden within the approval time limit check, then the requested system change will be denied.

The quantum nature of this system will be expanded in future iterations, but in its simplest for each administrator gets one or more of qubits of a specific energy state. Only when the qubits align, and the energy signatures verified can the object in question be opened.

### DETAILED DESCRIPTION OF DRAWINGS

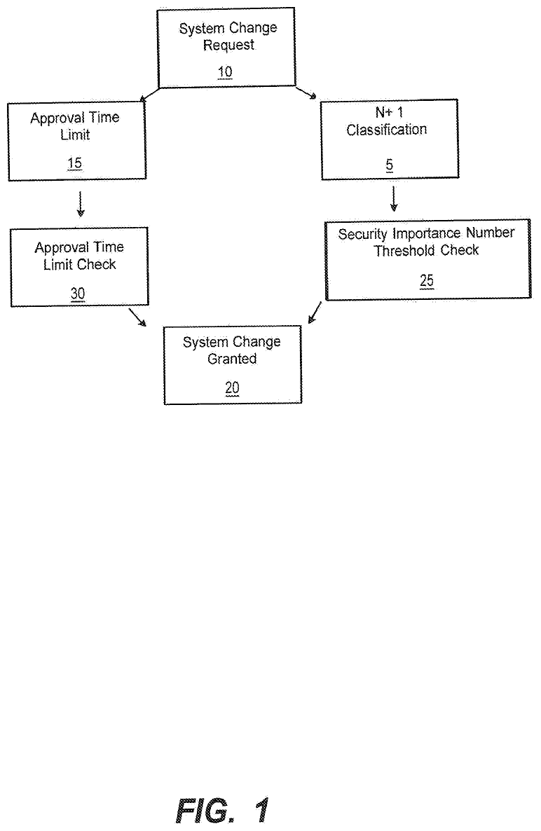

FIG. 1 depicts a flow chart which illustrates the order of operations regarding the cyber security system when the change is ultimately granted. First, an N+1 classification or a security importance number (5) is assigned to a particular object in the company's technical infrastructure. Then when a system change request (10) is made with regard to any object that has a security importance number associated with it, a security importance number threshold check (25) is made wherein administrators will have the ability to either approve or deny the change being requested. In this instance, the security threshold and approval time limit (15, 30) is met so the change is granted.

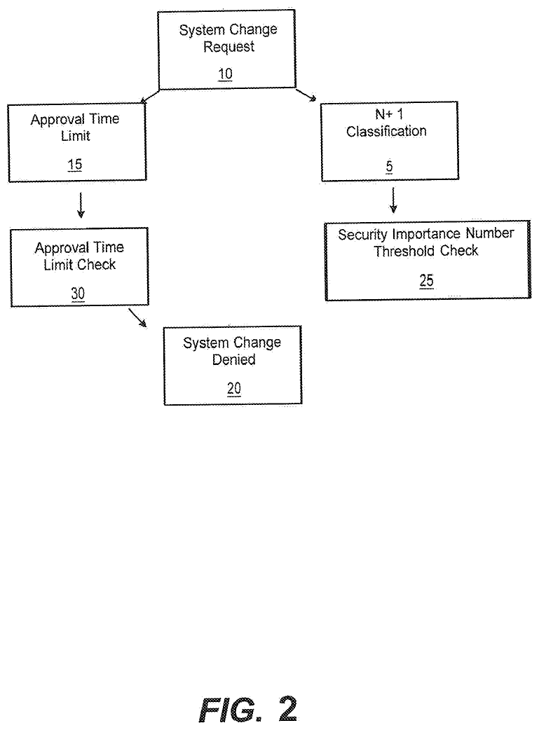

FIG. 2 depicts a flow chart which illustrates the order of operations regarding the cyber security system when the change is denied due to a failure to meet the security importance number threshold. First, an N+1 classification or a security importance number (5) is assigned to a particular object in the company's technical infrastructure. Then when a system change request (10) is made with regard to any object that has a security importance number associated with it, a security importance number threshold check (25) is made wherein administrators will have the ability to either approve or deny the change being requested. In this instance, the security threshold is not met, so the system change is denied.

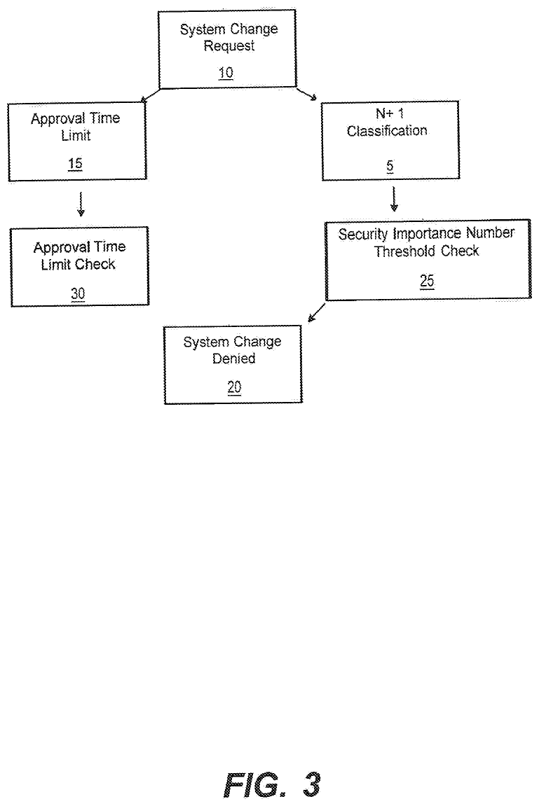

FIG. 3 depicts a flow chart which illustrates the order of operations regarding the cyber security system when the change is denied due to a failure to meet the approval time limit. First, an N+1 classification or a security importance number (5) is assigned to a particular object in the company's technical infrastructure. Then when a system change request (10) is made with regard to any object that has a security importance number associated with it, a security importance number threshold check (25) is made wherein administrators will have the ability to either approve or deny the change being requested. In this instance, while the security threshold is ultimately met, it was not met within the time limit.

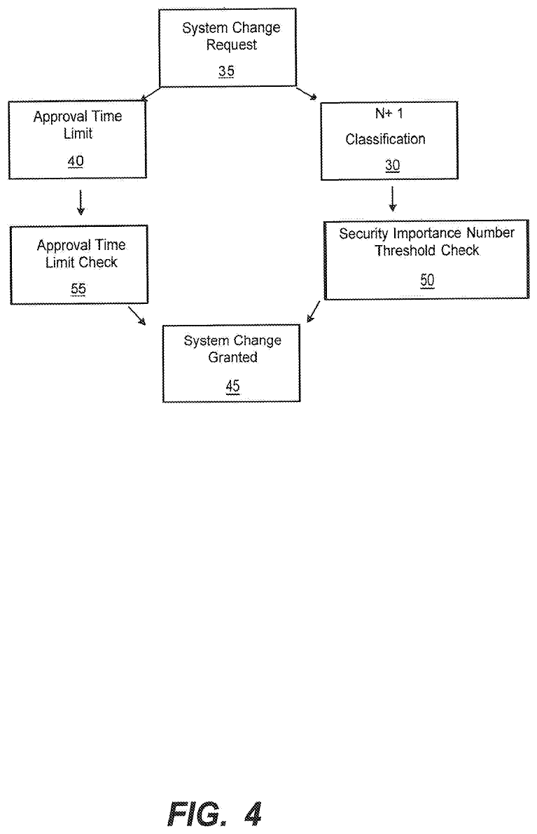

FIG. 4 depicts a flow chart which illustrates the order of operations regarding the cyber security system when the system change is probabilistically granted. First, an N+1 classification or a security importance number (30) is probabilistically assigned via machine learning to a particular object in the company's technical infrastructure. Then when a system change request (35) is made with regard to any object that has a security importance number associated with it, a security importance number threshold check (50) is probabilistically made wherein administrators will have the ability to either manually interfere within the assigned time limit to approve or deny the change being requested. In this instance, the security threshold and approval time limit (40, 55) is met so the change is granted.

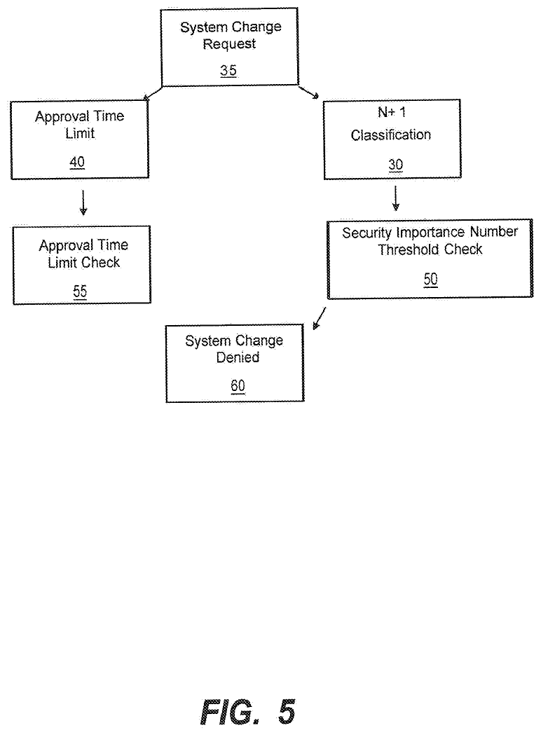

FIG. 5 depicts a flow chart which illustrates the order of operations regarding the cyber security system when the change is probabilistically denied due to a failure to meet the security importance number threshold. First, an N+1 classification or a security importance number (30) is probabilistically assigned to a particular object in the company's technical infrastructure. Then when a system change request (35) is made with regard to any object that has a security importance number associated with it, a security importance number threshold check (50) is probabilistically made wherein administrators will have the ability to either manually interfere within the assigned time limit to approve or deny the change being requested. In this instance, the security threshold is not met, nor did the administrators manually override the request within the approval time limit, so the system change is denied.

1. A cyber security system designed to prevent insider attacks and abuse of access by insiders and external actors, wherein objects in the technical infrastructure of a company are probabilistically assigned security importance numbers, system change requests are made, security importance number threshold checks are probabilistically made, approval time limits are defined, approval time limit checks are made, and system changes are granted or denied.

2. The cyber security system primarily designed to prevent insider attacks wherein objects in the technical infrastructure of the company are probabilistically assigned security importance numbers, system change requests are made, security importance number threshold checks are probabilistically made, approval time limits are defined, approval time limit checks are made, and system changes are granted or denied as in claim 1, wherein an object is probabilistically assigned an N+1 security importance number which determines the total number of generated administrator profiles which need to approve of the system change.

3. The cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 1, wherein the security importance number threshold check is probabilistically made to determine if the appropriate number of generated administrator profiles approve of the specific system change.

4. The cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 1, wherein the approval time limit is defined to give administrators an opportunity to interfere with generated administrator profile's likely outcome on the requested change.

5. The cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 1, wherein if the security importance number threshold check and approval time limit check are both passed, the requested change is granted.

6. The cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 1, wherein if either the security importance number threshold check is failed and there is no manual interference within the time limit check, then the system change is denied.

7. A method of using a cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied.

8. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein an object is probabilistically assigned an N+1 security importance number which determines the total number of generated administrator profiles which must approve of the system change.

9. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein the security importance number threshold check is probabilistically made to determine if the appropriate number of generated administrator profiles approve of the specific system change.

10. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein the approval time limit is defined to give administrators an opportunity to interfere with generated administrator profile's likely outcome on the requested change.

11. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein if the security importance number threshold check and approval time limit check are both passed, the requested change is granted.

12. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein if either the security importance number threshold check is failed and there is no manual interference within the time limit check, then the system change is denied.

13. The cyber security system primarily designed to prevent insider attacks wherein objects in the technical infrastructure of the company are probabilistically assigned security importance numbers, system change requests are made, security importance number threshold checks are probabilistically made, approval time limits are defined, approval time limit checks are made, and system changes are granted or denied as in claim 1, wherein administrative profiles are generated from previous behaviors and machine learning.

14. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein administrative profiles are generated from previous behaviors and machine learning.

15. The cyber security system primarily designed to prevent insider attacks wherein objects in the technical infrastructure of the company are probabilistically assigned security importance numbers, system change requests are made, security importance number threshold checks are probabilistically made, approval time limits are defined, approval time limit checks are made, and system changes are granted or denied as in claim 1, wherein administrative profiles are given likelihoods of acceptance or rejection of change requests based on previous actions.

16. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein administrative profiles are given likelihoods of acceptance or rejection of change requests based on previous actions.

17. The cyber security system primarily designed to prevent insider attacks wherein objects in the technical infrastructure of the company are probabilistically assigned security importance numbers, system change requests are made, security importance number threshold checks are probabilistically made, approval time limits are defined, approval time limit checks are made, and system changes are granted or denied as in claim 1, wherein security importance number thresholds are probabilistically assigned to objects based on previous behaviors and machine learning.

18. The method of using the cyber security system primarily designed to prevent insider attacks wherein objects in the technical infrastructure of a company are probabilistically assigned security importance numbers, system change requests are made, security importance number threshold checks are probabilistically made, approval time limits are defined, approval time limit checks are made, and system changes are granted or denied as in claim 7, wherein security importance number thresholds are probabilistically assigned to objects based on previous behaviors and machine learning.
